(19) United States
(12) Patent Application Publication
(10) Pub. No.: US 2003/0123865 A1
(43) Pub. Date: Jul. 3, 2003

(54) Zoom lens control system and method

(76) Inventors: Gregory V. Hofer, Loveland, CO (US); Jason E. Yost, Windsor, CO (US)

Correspondence Address: HEWLETT-PACKARD COMPANY, Intellectual Property Administration, P.O. Box 272400, Fort Collins, CO, 80527-2400, US

(21) Appl. No.: 10/022,781

(22) Filed: Dec. 13, 2001

(51) Int. Cl. G03B 17/00

(52) U.S. Cl. 396/72

(57) ABSTRACT

A method of controlling a zoom lens includes zooming to a desired focal length in one of two directions, and determining a focus lens position at least partly from the desired focal length based upon said one of said two directions.

### FIELD OF THE INVENTION

This invention relates generally to zoom lenses and more specifically to a zoom lens control system and method.

### BACKGROUND

Zoom lenses are employed by numerous types of imaging devices such as still and video cameras, etc. Some types of zoom lens assemblies include imprecise and/or low-resolution components such as drive systems or zoom position sensors which are employed because of their other advantages, such as low cost. Because of these imprecise and/or low-resolution components, a zoom lens assembly with a discrete number of zoom positions (or focal lengths) may come to rest at an offset from the desired zoom positions. Further, the direction in which a zoom position is approached by the zoom lens affects the direction of the offset from the desired zoom position. For example, if a zoom lens assembly includes focal lengths of 10 mm, 12 mm, and 14 mm among the discrete zoom positions measured by its discrete position sensor, and the zoom lens assembly is zoomed to the 12 mm position, the actual resulting offset from 12 mm differs depending upon the direction from which the zoom lens approaches 12 mm. If the zoom lens zooms from 10 mm to 12 mm, it may overshoot the 12 mm position by an offset, coming to rest at an actual focal length of 12.3 mm, for example. If the zoom lens zooms from 14 mm to 12 mm, it may overshoot the 12 mm position by an offset in the other direction, coming to rest at an actual focal length of 11.8 mm.

A typical solution to this problem is to ensure that the zoom lens always approaches desired zoom positions from the same direction. Thus, the zoom lens automatically reverses direction when finishing certain zoom operations, referred to herein as zoom lens reversal. For example, when zooming in, the zoom lens zooms in directly to the desired zoom position and stops. However, when zooming out, the zoom lens passes the desired zoom position, then reverses direction and briefly zooms in to ensure that the zoom operation always approaches the desired zoom position from the same zoom direction. This zoom lens reversal causes the zoom lens to stop at about the same offset from the desired zoom position regardless of the initial zoom lens position.

Unfortunately, zoom lens reversal slows operation of the zoom lens assembly and can be extremely disconcerting to a user, particularly when zooming while capturing video, since the back and forth zooming effect is noticeable in the resulting video. Thus, zoom lens reversal is not a satisfactory solution to problems which arise from imprecise and/or low-resolution components in a zoom lens assembly.

### SUMMARY

An embodiment of the invention may comprise a method of controlling a zoom lens, including zooming to a desired focal length in one of two directions, and determining a focus lens position at least partly from the desired focal length based upon said one of said two directions.

An embodiment of the invention may also comprise an optical apparatus having a zoom lens assembly with a variable focal length, and a zoom lens drive system connected to the zoom lens assembly to either increase or decrease the focal length of the zoom lens assembly. A zoom position sensor is connected to the zoom lens assembly for determining the focal length of the zoom lens assembly. A focus lens assembly is optically coupled to said zoom lens assembly, and the focus lens assembly is adjustable based at least in part on whether the focal length of the zoom lens assembly was last increased or decreased.

An embodiment of the invention may also comprise an imaging device having a zoom lens with at least one zoom element and at least one focus element. The imaging device includes means for adjusting at least one zoom element to either increase or decrease focal length. The imaging device also includes means for determining an appropriate setting for the at least one focus element based at least in part on whether the focal length of the at least one zoom element was last increased or decreased.

### BRIEF DESCRIPTION OF THE DRAWING

Illustrative and presently preferred embodiments of the invention are shown in the accompanying drawing, in which:

FIG. 1 is an isometric front view illustration of an exemplary imaging device with a zoom lens, with the zoom lens retracted;

FIG. 2 is an isometric rear view illustration of the exemplary imaging device of FIG. 1;

FIG. 3 is an isometric front view illustration of the exemplary imaging device of FIG. 1 with the zoom lens extended to the wide angle position;

FIG. 4 is an isometric front view illustration of the exemplary imaging device of FIG. 1 with the zoom lens extended to the telephoto position;

FIG. 5a is a side illustration of an exemplary zoom lens assembly in the retracted position;

FIG. 5b is a side illustration of an exemplary zoom lens assembly extended to the wide angle position;

FIG. 5c is a side illustration of an exemplary zoom lens assembly extended to the telephoto position;

FIG. 6 is an illustration of an exemplary zoom lens assembly with a zoom position encoder;

FIG. 7 is a chart illustrating an exemplary code ring for the zoom position encoder of FIG. 6;

FIG. 8 is an exemplary chart of zoom velocity versus zoom lens position for the zoom lens assembly of FIG. 6; and

FIG. 9 is an exemplary chart of focus lens position versus zoom lens position (or focal length) for a number of different focus object distances, for the zoom lens assembly of FIG. 6.

### DESCRIPTION OF THE PREFERRED EMBODIMENTS

The drawing and description, in general, disclose a zoom lens assembly which may include imprecise and/or low-resolution components such as drive motors or focal length sensors but which does not automatically reverse directions after changing focal length by zooming in or out. The drawing and description, in general, also disclose an imaging device with a zoom lens for which a focus lens position is calculated differently depending upon whether the focal length offset occurred from an inward zoom movement versus an outward zoom movement. By adjusting the focus information calculation based on the focal length offsets due to zoom direction, focus errors are prevented, thereby eliminating the need for zoom lens reversal. The type of focus related errors which are prevented depends upon whether the zoom lens is manually or automatically focused. In manual focus mode the system and method disclosed herein corrects focus errors. In automatic focus mode the system and method corrects errors in the descriptive focus information which is stored with captured images.

A traditional definition of the term focal length is the distance from the focal point where parallel image light rays converge to the lens, although similar definitions exist with some differences which are equally applicable herein, as long as they vary the magnification of objects in the field of view and have an impact on the focus lens position. The zoom position of a zoom lens assembly is typically indicated by the focal length, which is generally measured in millimeters (mm). Since the exemplary optical device discussed herein is a digital camera, a common focal length range of 7 mm to 18 mm is given, rather than the higher values in the focal length range of a 35 mm zoom lens. Digital cameras have photodetectors which are much smaller than a 35 mm negative. Therefore, the lenses can also be smaller, with correspondingly smaller focal lengths to produce the same magnification.

The zoom lens may be used in any optical device requiring an optical zoom capability, including imaging devices like cameras. Although the zoom lens and its control and operation will be described herein with respect to a digital camera, it is important to note that the zoom lens and its control and operation is not limited to use with any particular device.

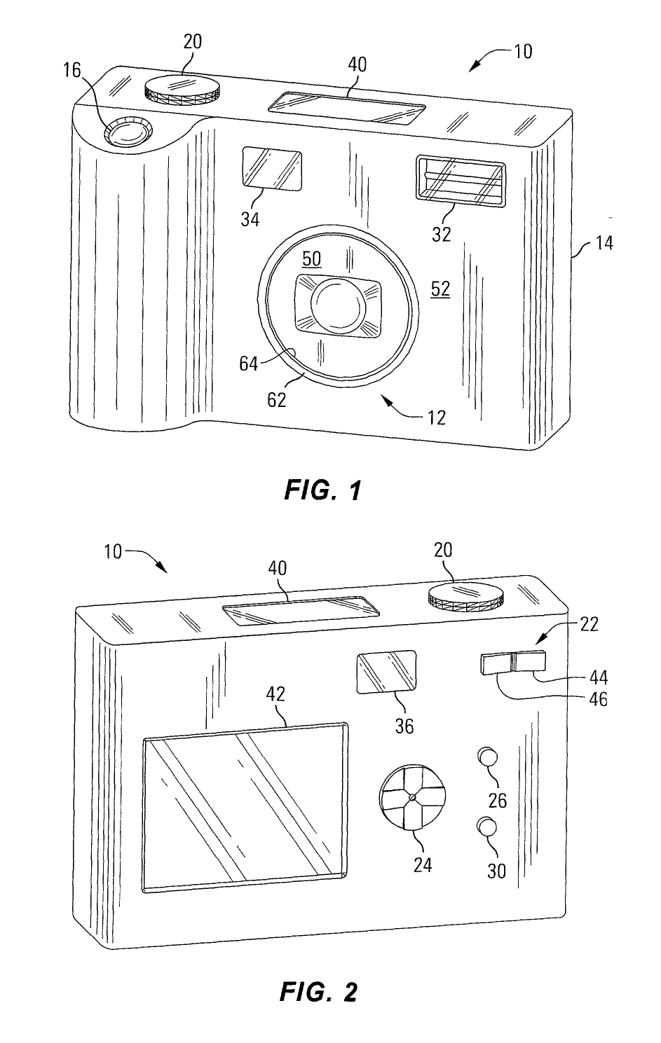

Referring now to FIGS. 1 and 2, an exemplary digital camera 10 which includes a zoom lens 12 will be described. The digital camera 10 comprises a housing portion or body 14 which is sized to receive the various systems and components required by the digital camera 10. For example, in the embodiment shown and described herein, the body 14 is sized to receive the zoom lens 12, a photodetector, a storage device to store the image data collected by the photodetector, and an image processing system to process and format the image data. The zoom lens 12 is located in the body 14 to allow light to enter the digital camera 10. The body 14 may also be sized to receive a power source such as a battery. Control buttons such as a shutter control button 16, a mode dial 20, a zoom control switch 22, and others (e.g., 24, 26, and 30) as needed are provided on the outside of the body 14. The digital camera 10 preferably includes an illumination system such as a flash 32 mounted on the outside of the body 14. Viewfinder windows 34 and 36 and display devices 40 and 42 are also located on the outside of the body 14. Each of the foregoing systems and devices will now be described.

Image light enters the digital camera 10 through the zoom lens 12. The photodetector detects the image light focused thereon by the zoom lens 12 and comprises a CCD, although other devices may be used. A typical CCD comprises an array of individual cells or pixels, each of which collects or builds-up an electrical charge in response to exposure to light. Since the quantity of the accumulated electrical charge in any given cell or pixel is related to the intensity and duration of the light exposure, a CCD may be used to detect light and dark spots in an image focused thereon.

The term image light as used herein refers to the light, visible or otherwise, that is focused onto the surface of the photodetector array by the zoom lens 12. The image light may be converted into digital signals in essentially three steps. First, each pixel in the CCD detector converts the light it receives into an electric charge. Second, the charges from the pixels are converted into analog voltages by an analog amplifier. Finally, the analog voltages are digitized by an analog-to-digital (A/D) converter. The digital data then may be processed and/or stored as desired.

A storage device is located in the body 14 of the digital camera 10 to store the image data collected by the optical imaging assembly. The storage device comprises a removable rewriteable non-volatile memory, or may comprise a random access memory (RAM), or a magnetic, optical, or other solid state storage medium. An image processing system is located in the body 14 of the digital camera 10 to process and format the image data, either before or after storage in the storage device. The image processing system preferably comprises a microprocessor and associated memory. Alternatively, the image processing system may comprise a hard-coded device such as an application specific integrated circuit (ASIC). The image processing system processes image data to scale images for display on a graphical display device 42, among other tasks. For example, the image processing system also zooms, pans, and crops images for display.

The graphical display device 24 comprises a liquid crystal display (LCD) or any other suitable display device. An alphanumeric display device 40 on the digital camera 10 also comprises an LCD or any other suitable display device, and is used to indicate status information, such as the number of images which can be captured and stored in the storage device, and the current mode of the digital camera 10.

The digital camera 10 may also include other components, such as an audio system. However, since digital cameras are well-known in the art and could be provided by persons having ordinary skill in the art after having become familiar with the teachings of the present invention, the digital camera 10 utilized in one embodiment of the present invention, as well as the various ancillary systems and devices (e.g., battery systems and storage devices) that may be utilized in one embodiment of the present invention will not be described in further detail herein.

During operation of the digital camera 10, the digital camera 10 is turned on and off by one of the control buttons such as the mode dial 20, and a mode is selected, such as a still image capture mode or a video capture mode. The digital camera 10 is oriented with the zoom lens 12 directed at a subject. The subject may be monitored either through a viewfinder 34 and 36, or on the graphical display panel 42. The focal length of the zoom lens 12 is adjusted by pressing a control button such as the zoom control switch 22. For example, when one side 44 of the zoom control switch 22 is pressed, the focal length of the zoom lens 12 increases to zoom in on the subject. When the other side 46 of the zoom control switch 22 is pressed, the focal length of the zoom lens 12 decreases to zoom out from the subject.

A focus region in the viewfinder 34 and 36 is directed at a focus object, an object in the field of view which is to be brought into focus, and focus lens elements in the zoom lens 12 are adjusted to focus image light from the focus object onto the photodetector. When the digital camera 10 is properly oriented, zoomed and focused, the shutter control button 16 is pressed. The flash 32 illuminates the subject, if needed. The photodetector then converts the image light directed thereon by the zoom lens 12 into electrical image data, which are stored in the storage device. The image processing system then processes the image data and displays the captured image on the display device 42.

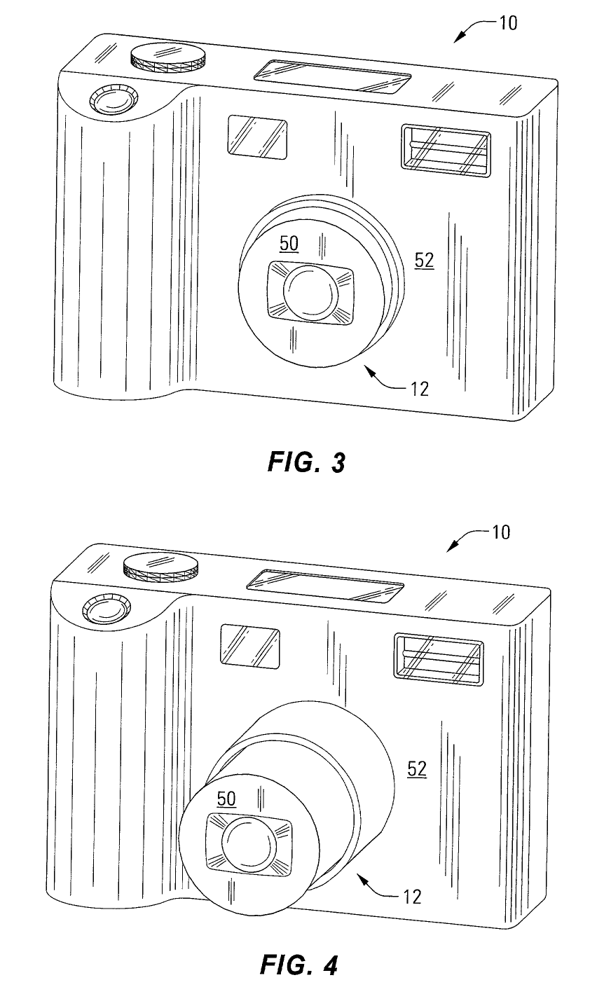

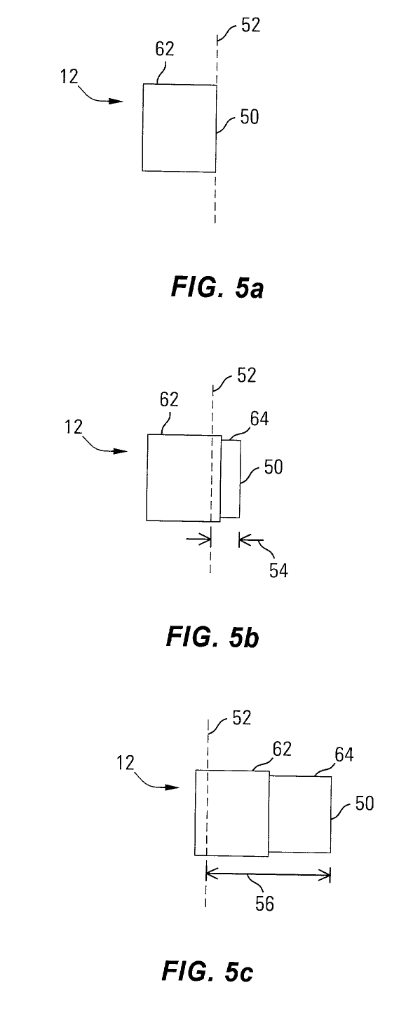

Note that the zoom lens 12 in an exemplary embodiment is retractable, that is, the zoom lens 12 can be retracted into the body 14 of the digital camera 10 so that the front 50 of the zoom lens 12 is substantially flush with the front 52 of the digital camera 10, as illustrated in FIGS. 1 and 5a. The zoom lens 12 is retracted when the digital camera 10 is turned off to minimize the size of the digital camera 10 and to prevent damage to the zoom lens 12. When the digital camera 10 is turned on and the zoom lens 12 is zoomed to its smallest focal length, capturing the widest angle possible, the zoom lens 12 extends a small distance 54 from the front 52 of the digital camera 10, as illustrated in FIGS. 3 and 5b. When the zoom lens 12 is zoomed to its greatest focal length, extending to the telephoto position, the zoom lens 12 extends a larger distance 56 from the front 52 of the digital camera 10, as illustrated in FIGS. 4 and 5c.

It is important to note again that the zoom lens 12 is not limited to use with any particular optical or imaging device, and is thus not limited to the details given above for the exemplary digital camera 10. Furthermore, the zoom lens 12 is not limited to the exemplary embodiment discussed in detail herein, but may be adapted as desired. For example, the exemplary zoom lens is described herein as having three barrels, but may have any alternative configuration. The zoom positions or focal lengths of the zoom lens 12 may also reversed, so that the most extended position of the zoom lens 12 would be the wide angle position rather than the telephoto position, thus reversing FIGS. 3 and 4.

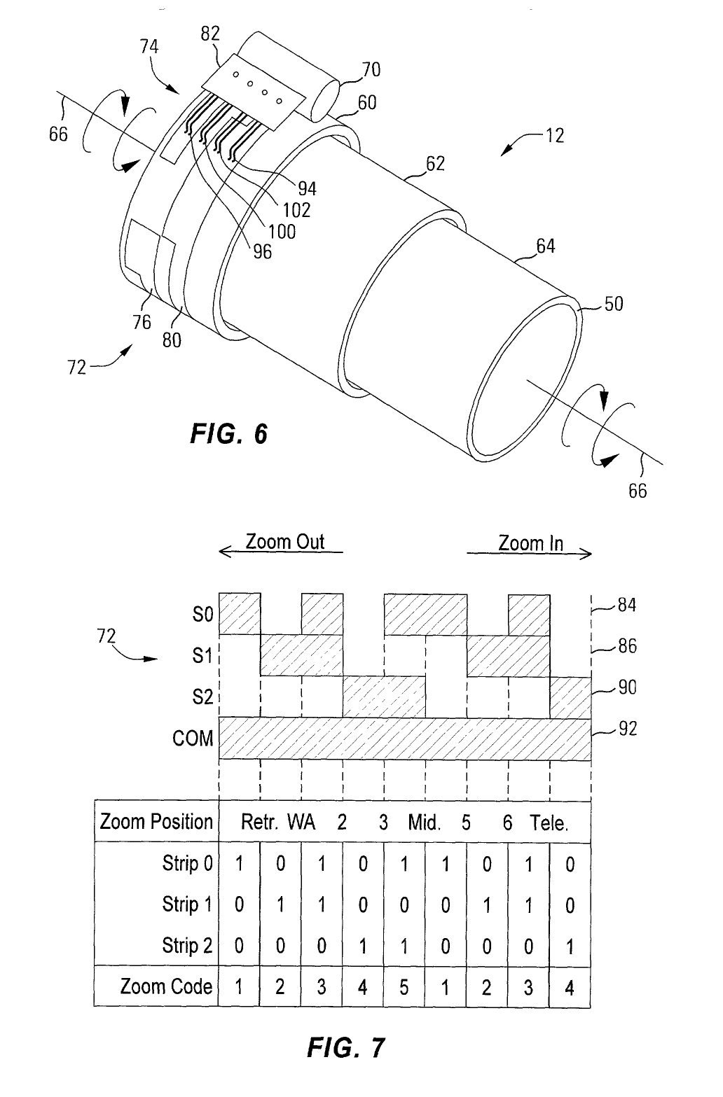

Referring now to FIG. 6, the zoom lens 12 will be described in more detail. An exemplary embodiment of the zoom lens 12 has three barrels 60, 62, and 64, two of which (62 and 64) extend out of the body 14 of the digital camera 10 as the focal length is adjusted, and one 60, the outermost barrel, which remains inside the digital camera 10. The outermost barrel 60 rotates around the optical axis 66 of the zoom lens 12, thereby extending the inner barrels 62 and 64 to adjust the focal length. The zoom lens 12 also includes focus lens elements which may comprise one or more lenses to adjust the focus of the zoom lens 12, and which are automatically adjusted by one or more focus lens motors. The zoom lens assembly may include imprecise and/or low-resolution components such as a direct current (DC) zoom drive motor 70 to adjust the focal length and a zoom sensor having a code ring 72 and a set of electrically conductive contacts 74 to determine discrete focal length positions.

Using a DC zoom drive motor 70 inexpensively provides greater torque than more precise alternatives such as a stepper motor, enabling the zoom lens 12 to be retracted into the body 14 of the digital camera 10. However, the position of the DC zoom drive motor 70 cannot be directly controlled. Thus, the zoom sensor is provided to measure the focal length as it is changed. A code ring 72 in the zoom sensor is wrapped around the outermost barrel 60 and consists of a set of electrically conductive surfaces (e.g., 76 and 80) forming a pattern around the barrel 60. The set of electrically conductive contacts 74 are mounted in place over the code ring 72, for example on a printed circuit board 82, so that the contacts 74 press against the code ring 72. The barrel 60 and the code ring 72 are rotated around the optical axis 66 of the zoom lens 12 by the zoom drive motor 70 to adjust the focal length, while the set of electrically conductive contacts 74 remain fixed in place. Therefore, the rotating code ring presents a changing pattern which the electrically conductive contacts 74 detect, and the pattern can be decoded to indicate the current focal length of the zoom lens 12 in discrete increments.

An exemplary code ring 72 is illustrated in FIG. 7 as it would appear when flattened rather than wrapped around the barrel 60 in the zoom lens 12. The exemplary code ring consists of four rows or strips 84, 86, 90, and 92 placed side by side, with some portions being substantially electrically conductive and other portions being substantially electrically nonconductive. (In FIG. 7, the electrically conductive portions are shaded.) Three of the strips 84, 86, and 90 present the changing pattern of electrical conductivity and the last strip 92 is a common strip which is uniformly electrically conductive.

The three encoded strips, strip 0 (SO) 84, strip 1 (S1) 86, and strip 2 (S2) 90 may represent binary encoded numbers which are incremented in order. Alternatively, the three encoded strips 84, 86, and 90 may have any suitable pattern. The zoom lens 12 has a given number of discrete focal lengths or zoom positions, seven in this example, ranging from wide angle to telephoto, plus a retracted position, as illustrated in the Zoom Position row of the chart of FIG. 7.

The exemplary code ring 72 may be formed as a solid electrically conductive ring wrapped around the barrel 60, with portions of the solid ring coated with an electrically nonconductive material to create the pattern. All electrically conductive portions are therefore electrically connected since they are formed of a single solid ring. The pattern may be detected by electrically grounding the common strip 92 of the code ring 72 or its associated electrically conductive contact 94 which presses against the common strip 92. Pull-up resistors are then connected to the other electrically conductive contacts 96, 100, and 102, which detect strips 0 84, 1 86, and 2 90, respectively, of the code ring 72. As the code ring 72 rotates, when the electrically conductive contacts 96, 100, and 102 are pressed against electrically nonconductive portions of the code ring 72, they will be pulled up to a high voltage by the pull-up resistors. When the electrically conductive contacts 96, 100, and 102 are pressed against electrically conductive portions of the code ring 72, they will be pulled down to ground through the common strip 92, registering a zero voltage. Thus, the changing voltage on the electrically conductive contacts 96, 100, and 102 can be measured to detect the pattern on the code ring 72.

Alternatively, the code ring 72 may have any form and structure indicating zoom positions that can be detected by a sensor.

The pattern presented by the three encoded strips 84, 86, and 90 of the code ring 72 changes at each discrete zoom position offered by the zoom lens 12. Thus, as the barrel 60 and code ring 72 rotate, the set of electrically conductive contacts 74 detect the transitions of the code ring patterns. The zoom lens 12 stops when the set of electrically conductive contacts 74 detect the transition indicating the desired focal length or zoom position.

As mentioned above, the focal length of the zoom lens 12 is adjusted by pressing the zoom control switch 22 (FIG. 2). Because the zoom lens 12 has a discrete number of zoom positions, the zooming action of the zoom lens 12 generally does not stop immediately when the zoom control switch 22 is released. Rather, after the zoom control switch 22 is released, the zoom lens 12 continues zooming until the next discrete zoom position is reached. For example, if the zoom lens 12 includes zoom positions with focal lengths of 12 mm and 14 mm, and the zoom control switch 22 is pressed causing the zoom lens 12 to zoom in from 12 mm then immediately released when the zoom lens 12 is at a focal length somewhere around 13 mm, the zoom lens 12 will continue to zoom in until the sensor detects the code ring 72 transition indicating the 14 mm focal length, at which point the zoom lens 12 will stop.

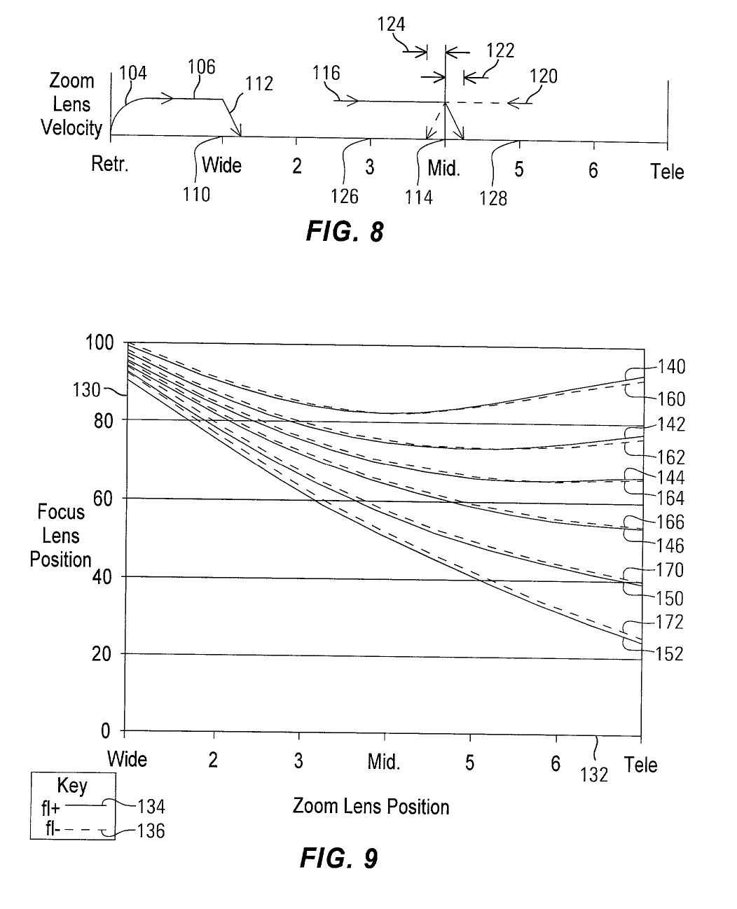

This exemplary combination of a DC zoom drive motor 70 and a discrete or granular zoom position sensor such as the code ring 72 described above enables the zoom lens 12 to be produced inexpensively and to have enough torque to rapidly zoom and retract into the optical device. However, it causes the zoom lens 12 to overshoot desired focal lengths because the zoom drive motor 70 cannot stop instantaneously after the zoom position sensor has detected the desired focal length. As illustrated in FIG. 8, the zoom lens 12 overshoots desired focal lengths, causing an offset in the focal length in the direction in which the zoom lens 12 was traveling. For example, the zoom lens 12 is brought from its retracted position by applying a constant voltage to the DC zoom drive motor 70, causing its velocity to increase 104 until it is constant 106, with the focal length of the zoom lens 12 increasing to the first zoom position 110. As soon as the zoom position sensor detects the desired zoom position, such as the wide angle position 110 on the rotating code ring 72, the power is removed from the DC zoom drive motor 70, causing it to stop. However, it takes a small amount of time for the velocity of the zoom lens 12 to decrease 112 to zero, causing the zoom lens 12 to overshoot the desired zoom position 110.

As mentioned above, the direction of the overshoot of desired zoom positions is dependent upon the zoom direction. For example, the ‘zoom in’ portion 44 of the zoom control switch 22 can be pressed to zoom in past the 3^{rd} zoom position 126 (FIG. 8). When the zoom control switch 22 is released at some point between the 3rd zoom position 126 and the middle zoom position 114, the zoom lens 12 continues to zoom in until the zoom position sensor detects the pattern for the middle zoom position 114 on the code ring 72. At that point, the zoom lens 12 begins to stop, coming to rest a short distance 122 or focal length offset from the desired middle zoom position 114. With the zoom lens 12 approaching from the other direction, when the zoom out portion 46 of the zoom control switch 22 is pressed, the zoom lens 12 zooms out past the 5^{th} zoom position 128. When the zoom control switch 22 is released at some point between the 5th zoom position 128 and the middle zoom position 114, the zoom lens 12 continues to zoom out until the zoom position sensor detects the pattern for the middle zoom position 114 on the code ring 72. At that point, the zoom lens 12 begins to stop, coming to rest a short distance 124 or focal length offset from the desired middle zoom position 114, but in the opposite direction from the offset 122 when zooming in.

In an exemplary zoom lens 12 in which a DC zoom motor drive is used it may take between about 100 to 300 ms for the zoom lens to travel between zoom positions, and about 50 ms for the motor to stop upon reaching a desired zoom position. Thus, an overshoot (e.g., 122) may cause a significant focal length error. By allowing the zoom lens 12 to approach zoom positions (e.g., 114) from either direction, either zooming in 116 or zooming out 120, the total tolerance in focal length for a given zoom position 114 is equal to the sum of the overshoot offsets in both directions 122 and 124. The magnitude of the focal length overshoot offsets are not necessarily the same in both directions, since the resistance of the zoom lens 12 to zooming may not be the same in both directions.

Note that focal length overshoot in the zoom lens 12 is often not important to the user since the zoom position is adjusted to pleasingly frame a subject, not to reach a given focal length. However, these offsets in the focal length should be taken into account when calculating focus lens position, since the focus lens position for the zoom lens 12 is based on the focal length of the zoom lens 12 as well as the distance to a focus object or subject. Assuming that the offsets in the focal length caused by zoom lens overshoot are acceptable, the focus lens position may be correctly calculated by taking into account the last direction of zoom, that is, whether the zoom lens 12 arrived at a given zoom position by zooming in or out.

The correct position of the focus lens or lenses is based on the distance from the digital camera 10 to a focus object and on the focal length of the zoom lens 12. Note that the focus lens position can be determined indirectly by the state of the focus lens positioning motor or any other suitable manner. Since the focus lens in one exemplary embodiment is driven by the focus lens positioning motor through a linkage or drive mechanism, the focus lens position can be treated indirectly by using the degrees of angle (for a DC motor), or steps (for a stepper motor), of the focus lens positioning motor. However, indirect controls such as these ultimately refer back to the position of the focus lens. The zoom lens 12 and the method of controlling the zoom lens 12 disclosed herein are not limited to direct reference to the zoom lens position, but can use any control that relates back to the zoom lens position.

The digital camera 10 or optical device determines the focus lens position after zooming operations. The uses for the focus lens position may vary depending on the current mode of the digital camera 10s. In manual focus mode, the digital camera 10 focuses the zoom lens 12 according to the focus lens position which is calculated after a zooming operation based on the actual focal length and the desired distance to the focus object. In automatic focus mode, the digital camera 10 may automatically detect the proper focus by moving the focus motor while monitoring the contrast of the focus object image. When the automatic focus process is complete, the focus motor is moved to the position where the maximum contrast was detected. In this case, the resulting focus distance is calculated based on focal length including offsets and the focus lens position. The focus distance information may be displayed on the graphical display device 24 and may be used to identify and describe stored images by storing the focus object distance with the images.

The relationship between the three variables, focus lens position, focal length (including offsets), and focus object distance, can be represented by a set of curves on a graph as in FIG. 9. The focus lens position is plotted along the Y-axis 130, with the range of focus lens positions scaled from 0 to 100. The zoom lens position, or focal length, is plotted along the X-axis 132, ranging from the wide angle position to the telephoto position.

Two sets of curves are provided, one for use after zooming in, or increasing the focal length, and the other for use after zooming out, or decreasing the focal length. The set of curves for use after zooming in is referred to in the graph as ‘focal length plus’ (fl+) 134, since after zooming in the overshoot causes the resulting focal length to be greater than desired. The set of curves for use after zooming out is referred to in the graph as ‘focal length minus’ (fl−) 136, since after zooming out the overshoot causes the resulting focal length to be less than desired. A curve is supplied in each set fl+ 134 (e.g., 140 and 142) and fl− 136 (e.g., 160 and 162) for a number of different focus object distances. (Note that a small number of curves is shown in FIG. 9 for clarity.) The fl+ curves 134, including curves 140, 142, 144, 146, 150, and 152, each apply to a different focus object distance, such as a close-up distance of 0.2 m (curve 140) and a distance of infinity ∞ (curve 152), the focus position which places objects out to the horizon in focus. The fl− curves 136, including curves 160, 162, 164, 166, 170, and 172, also each apply to a different focus object distance, such as a close-up distance of 0.2 m (curve 160) and a distance of infinity ∞ (curve 172).

The data for the focus lens position and focus object distance in the two sets of curves 134 and 136 are corrected for focal length overshoot offsets, so that when they are plotted against the target focal lengths along the X-axis 132, the two sets of curves 134 and 136 differ. The fl+ curves 134 are corrected for the positive offset from the desired focal lengths, and the fl− curves 136 are corrected for the negative offset from the desired focal lengths. Otherwise, the two sets of curves for fl+ and fl− would be identical and there would essentially be only one set of curves, which would be appropriate if the zoom lens 12 were able to stop exactly on the target zoom positions.

The two sets of curves 134 and 136 illustrated in FIG. 9 show only a limited set of the possible focus object distances for illustrative purposes. The three variables, focus lens position, focal length, and focus object distance, may alternatively be plotted with the focus lens position plotted along the Y-axis 130 and the focus object distance plotted along the X-axis 132, with a curve given on the graph for each discrete zoom position to show a more complete set of focus object distances.

The digital camera 10 can be provided with these curves, for example, in the form of lens design equations, from which it can calculate the focus lens position after a zooming operation. However, if calculating the focus lens position from the curves described above requires more than the available processing power of the digital camera 10 or other optical device, or if the precision of continuous values is not required, the focus lens position information may be stored in one or more lookup tables, as in the following exemplary lookup tables which indicate focus lens position:

| | Zoom Position | | | | | | |
|---|---|---|---|---|---|---|---|
| | WA | 2 | 3 | M | 5 | 6 | T |
| | Focal Length | | | | | | |
| Focus Object Distance | 7 | 8 | 10 | 12 | 14 | 16 | 18 |

Focal Length Plus (fl+)

| | | | | | | | |
|---|---|---|---|---|---|---|---|
| Infinity | 91 | 77 | 64 | 49 | 38 | 35 | 23 |
| 5 m | 92 | 79 | 67 | 54 | 49 | 44 | 38 |
| 2 m | 93 | 80 | 72 | 63 | 58 | 56 | 53 |
| 1 m | 95 | 83 | 75 | 70 | 70 | 70 | 71 |
| 0.5 m | 96 | 87 | 79 | 75 | 76 | 78 | 80 |
| 0.2 m | 98 | 92 | 88 | 84 | 88 | 92 | 96 |

Focal Length Minus (fl+)

| | | | | | | | |
|---|---|---|---|---|---|---|---|
| Infinity | 93 | 79 | 67 | 52 | 40 | 37 | 25 |
| 5 m | 94 | 81 | 70 | 57 | 51 | 46 | 40 |
| 2 m | 95 | 82 | 74 | 65 | 60 | 57 | 54 |
| 1 m | 97 | 85 | 76 | 70 | 70 | 69 | 68 |
| 0.5 m | 98 | 89 | 81 | 76 | 76 | 77 | 78 |
| 0.2 m | 100 | 94 | 89 | 84 | 87 | 90 | 94 |

In automatic focus operation, after the zoom lens 12 is adjusted to the desired zoom position, the focus lens is adjusted until maximum image contrast is achieved. The focus object distance is then determined by searching for the focus lens position in the column for the current zoom position in one of the lookup tables above and reading out the corresponding focus object distance. The lookup table used depends on the direction of the last zoom performed. In manual focus operation, after the zoom lens 12 is adjusted to the desired zoom position, the focus lens position is determined by searching for the focus object distance in one of the lookup tables above and reading out the focus lens position from the column for the current zoom position. Again, the lookup table used depends on the direction of the last zoom performed.

Note that in practice, the lookup tables may contain as many entries as desired to balance the precision requirements with the amount of memory required to store the tables. For example, the lookup tables may be sparsely populated, but the optical device would need to select the closest appropriate values or interpolate between values. Alternatively, the lookup tables may be densely populated, increasing the memory requirements but also increasing precision. For example, if the focus motor is a stepper motor with a given number of discrete positions, the lookup tables may contain all the possible entries which correspond to available discrete focus motor positions. (Note that in the exemplary lookup table above, multiple different combinations of focal lengths and focus object distances correspond to the same focus positions, such as position 94 in the bottom row of the fl− table.) If exact values are not found in the lookup tables, the nearest available value may be applicable due to the depth of field of the zoom lens 12 at those settings, which keeps objects within a certain distance from the focus object in focus.

In an alternative embodiment, if the differences between the values in the fl+ and fl− tables are substantially constant for each curve or for the entire table, a single lookup table can be provided with an offset applied to the values from the table, where the offset would either be added or subtracted depending on the direction of the last zoom operation. However, for the differences to be substantially constant, the graph of the values as in FIG. 9 would have to have substantially constant slopes.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method of controlling a zoom lens, comprising:
zooming to a desired focal length in one of two directions; and
determining a focus lens position for said zoom lens at least partly from said desired focal length based upon said one of said two directions.

2. The method of claim 1, further comprising focusing said zoom lens according to said focus lens position.

3. The method of claim 1, further comprising storing said focus lens position to describe optical data received through said zoom lens.

4. The method of claim 1, wherein said two directions comprise zooming in to increase focal length and zooming out to decrease focal length.

5. The method of claim 4, wherein said focus lens position is different after zooming in to said desired focal length than after zooming out to said desired focal length.

6. The method of claim 1, wherein said determining said focus lens position from said desired focal length comprises determining to which current zoom position among a plurality of zoom positions said zoom lens is zoomed and calculating said focus lens position based on said current zoom position.

7. The method of claim 1, wherein said determining said focus lens position comprises calculating said focal information using one of two data sets relating focal length, focus lens position, and distance to a focus object, wherein a first of said two data sets is applicable subsequent to zooming in and a second of said two data sets is applicable subsequent to zooming out.

8. The method of claim 7, wherein said two data sets comprise lookup tables.

9. The method of claim 7, wherein said two data sets each define a plurality of curves on a graph of focal length versus focus lens position, with a curve for each of a plurality of focus object distances.

10. The method of claim 7, wherein said two data sets each define a plurality of curves on a graph of focus object distance versus focus lens position, with a curve for each of a plurality of focal lengths.

11. The method of claim 7, further comprising interpolating between data points in said one of said two data sets if an exact value is not included.

12. The method of claim 1, wherein said determining said focus lens position comprises identifying said focal information from one of two sets of lookup tables, each of said two sets of lookup tables containing at least one lookup table, said lookup tables containing data relating focal length to focus lens position, wherein a first of said two sets of lookup tables is applicable subsequent to zooming in and a second of said two sets of lookup tables is applicable subsequent to zooming out.

13. Optical apparatus comprising:
a zoom lens assembly having a variable focal length;
a zoom lens drive system connected to said zoom lens assembly to either increase or decrease a focal length of said zoom lens assembly;
a zoom position sensor connected to said zoom lens assembly for determining said focal length of said zoom lens assembly; and
a focus lens assembly optically coupled to said zoom lens assembly, wherein said focus lens assembly is adjustable based at least in part on whether said focal length of said zoom lens assembly was last increased or decreased.

14. The optical apparatus of claim 13, further comprising a control system connected to said zoom position sensor, wherein said control system determines a last direction of change of said zoom lens assembly indicating whether said focal length of said zoom lens assembly was last increased or decreased, and wherein said control system calculates a configuration for said focus lens assembly based on said focal length and said last direction of change.

15. The optical apparatus of claim 14, wherein said control system calculates said configuration for said focus lens assembly based also on a distance to a focus object.

16. The optical apparatus of claim 14, said control system comprising two lookup tables containing data correlating a position of said zoom lens assembly, a position of said focus lens assembly, and a distance to a focus object, wherein a first of said two lookup tables is applicable when said focal length of said zoom lens assembly was last increased, and wherein a second of said two lookup tables is applicable when said focal length of said zoom lens assembly was last decreased.

17. The optical apparatus of claim 13, wherein said zoom lens drive system comprises a direct current motor.

18. The optical apparatus of claim 13, wherein said zoom position sensor comprises a code ring on said zoom lens assembly and at least one electrically conductive contact pressing against said code ring to read a code from said code ring as said code ring turns with said zoom lens assembly.

19. An imaging device, comprising:
a zoom lens having at least one zoom element and at least one focus element;
means for adjusting said at least one zoom element to either increase or decrease focal length; and
means for determining an appropriate setting for said at least one focus element based at least in part on whether said focal length of said at least one zoom element was last increased or decreased.
